(19) United States
(12) Patent Application Publication
(10) Pub. No.: US 2016/0121908 A1
(43) Pub. Date: May 5, 2016

(54) ZERO ENERGY TRANSPORTATION SYSTEM

(71) Applicant: Othman bin AHMAD, Petagas, Kota Kinabalu (MY)

(72) Inventor: Othman bin AHMAD, Petagas, Kota Kinabalu (MY)

(21) Appl. No.: 14/372,209

(22) PCT Filed: May 1, 2013
(86) PCT No.: PCT/IB2013/053428

§ 371 Date: Jul. 14, 2014

(51) Int. Cl. B61B 13/12; B61B 13/10; B65G 51/02

(52) U.S. Cl. CPC B61B 13/122; B65G 51/02; B61B 13/10

(57) ABSTRACT

A transportation system for people as well as goods that preserves energy by utilising the zero energy travel principle where energy is recycled instead of being wasted as heat or noise. An air tight and self-contained carriage (400) travels in a low pressure tube (100) that is completely sealed in order to maintain the low pressure. Electrical vacuum pumps (200), each equipped with a release valve, are used to remove air or discharge air that is above the desired low pressure, inside the tube (100), and are operated in such a way that the vacuum pumps help the propulsion of the vehicle. The carriages (400) or vehicles (450) themselves help in creating the vacuum by being fitted with seals (300)(350) that can vary in shape and size so as to allow the vehicles (400)(450) to behave as a vacuum pump or to allow the vehicles (400)(450) to be propelled by excess air pressure at the back due to the switching off of vacuum pumps (200) or leaked air. The transportation system can also be used for a vertical movement as shown by air tight elevators (600) equipped with seals (700) moving inside an elevator shaft (800) where vacuum pumps (200) are installed and operated in such a way as to assist the movement of the elevators (600) or alternatively the elevators (700) operating as vacuum pumps.

### 1. FIELD OF THE INVENTION

The present invention relates to a transportation system for goods and people with the least energy cost and maximum comfort.

### 2. BACKGROUND OF THE INVENTION

It is not widely understood that we can move objects from one location to another location with zero energy. We can easily achieve this by using vacuum to reduce air drag and magnetic levitation to reduce contact friction. Magnetic levitation can be achieved with minimal loss by using superconductivity where we can achieve zero electrical energy loss in a wire. To achieve the net zero energy during travelling, we need to recover the kinetic energy back to its power source. Two techniques allow us to theoretically recover up to 100% without much loss: gravity and electricity. Gravity does not even need any energy input but it does not allow us much control. Electricity is better but it requires expensive energy storage devices as well as motors, but electrical energy can be controlled at will. Electrical energy conversion loss is very low, can be less than one %, as had been achieved by electrical generators. Technologies exist that allow us to travel with zero energy but the cost will be high. This invention will allow us to implement zero energy transportation system with much lower cost by lowering the cost of creating the vacuum which is essential towards zero energy travelling. The cost may still be high compared to existing transportation systems partly because the new technologies need to be developed to the mass production state, but the advantages should make the effort worthwhile. Reduction in the usage of energy is only a minor contribution to the viability of a transportation system. By reducing the energy loss, we can achieve high speed and comfort at the expense of some safety.

By reducing the energy loss, a vehicle can travel more comfortable because it is the energy loss in the form of noise and vibration that causes the most discomfort. Travelling in a vacuum will be very comfortable indeed, because wind noise is reduced considerably. If we travel using maglev (magnetic levitation), comfort level will be even higher because contact noise will be much reduced. It is not necessary to travel at high speed in order to enjoy the advantages of vacuum transportation system but vehicles travel much faster than aeroplanes in vacuum because it is the air drag that limits the speed of aeroplanes. By removing air, vehicles can travel at more than 8000 km/hr so that we can travel from London to New York in just an hour.

Travelling at such high speed will be much more dangerous but with proper safety precautions, loss will be minimised. At the initial stage, in order to perfect the development of the technologies to enable us to travel safely in a vacuum, we can start by transporting goods only. The advantages are so immense in the era of diminishing resources, global warming and environmental pollution, that it is inevitable that we should be travelling in vacuum tunnels and tubes soon. The safety argument is similar to the argument of DC versus AC electrical transmissions and the outcome was very clear for us to learn. The safety issues are real but we can always take safety measures to minimise any loss due to accidents or faults.

The inventor had first published a paper describing the principle of zero energy travel in an online journal in 2011 (Optimum Low Friction Energy Saving Car. Ahmad, O., Kiring, A and Chekima, A., Electronic Journal of University Malaya, Engineering e-Transaction, Volume 6. ISSN 1823-6379). Zero energy travel term and some methods of exploiting it, one of which is a vacuum tunnel straight through the side of the earth, had been disclosed online by the inventor at Wikimedia, http://commons.wikimedia.org/wiki/, in files Zero_energy_transatlantic.jpg and Zero_energy_transatlantic.jpg in 2011. Despite the obviousness of the zero energy travel principle as derived from Newton's Laws of Motion, there is no known fiction claiming to require zero energy while moving objects at high speed, although these zero energy techniques of travelling in low speed are well documented in the Tarzan fictional stories in 1912 (Burroughs, Edgar Rice. Tarzan of the Apes. Published by A. C. McClurg), prior to the disclosure of the zero energy travel principle in 2011. In 2012, there was a movie about a high speed zero energy travelling technique, called Total Recall (2012)(Wiseman, Len. Total Recall 2012. Miramax Films.). The device, called the Fall, relies on falling straight through the centre of the earth and emerging at the other side of the earth. However, vacuum tunnels are described in fictional books a few times. Vacuum tunnels are also described in a documentary film made in 2003 (Giotta, Joseph. Extreme Engineering: The Transatlantic tunnel. Powderhouse Productions) and an article in 2004, called the Transatlantic Tunnel (Hoffman, Carl. Trans-Atlantic MagLev: Vacuum Tube Train. Popular Science. Apr. 12, 2004). The description of the transportation system is very detailed but there was no mention on how the vacuum could be created, apart from the fact that it will be a challenge, and no attempt at all to recover the kinetic energy of the train.

There is a patent approved in 1999, U.S. Pat. No. 5,950,543 (Oster, 1999), describing an evacuated tube transportation system complete with kinetic energy recovery and magnetic levitation. It may qualify as a zero energy transportation system but it does not take into account the methods of creating and controlling the vacuum, let alone using the vacuum as a propulsion system. Another patent approved in 1970, U.S. Pat. No. 3,522,773 (Edwards, 1970), actually uses a vacuum pump in front of the carriages, but allows air to flow at the back but there is no energy recovery system. U.S. Pat. App. No. US 2010/0083864 uses seals at the carriages, but these vacuum seals are fixed in size and shape and are meant for propulsion only. Other Pneumatic transport system patents, such as U.S. Pat. No. 5,253,590 (Marusak, 2010), exist but suffer from high energy loss most of the time since air drag is very high and energy conversion from vacuum pumps to kinetic energy is not very efficient.

Other magnetic levitation techniques are used in the patents U.S. Pat. No. 5,319,275 (Tozoni, 1994), U.S. Pat. No. 5,291,834 (Quaas, 1994), U.S. Pat. No. 5,319,336 (Alcon, 1994), U.S. Pat. No. 5,452,663 (Berdut, 1994). In addition, vacuum transport systems also exit but suffer from the practical point of view apart from the difficulty in creating the vacuum such in patents U.S. Pat. Nos. 3,954,064, 4,075,948, 4,148260 (Minovitch), U.S. Pat. No. 5,513,573 (Sutton), U.S. Pat. No. 5,433,155 (O'Neil et al.), U.S. Pat. No. 2,511,979 (Goddard), U.S. Pat. No. 5,435,253 (Milligan), U.S. Pat. Nos. 4,791,850, 4,795,113 (Minovitch) and U.S. Pat. No. 4,881,446 (Marks).

Still widely used Pneumatic Tube Transport are systems as in patents such as U.S. Pat. No. 5,234,292 (Lang, 1993), U.S. Pat. No. 4,715,750 (Podoll-Jensen, 1987) in which cylindrical containers are propelled through a network of tubes by compressed air or by partial vacuum. Because it relies only on the vacuum for propulsion, only light weight items can be reliably transported, and it needs constant energy input and does not have any means to recover energy.

### 3. SUMMARY OF THE INVENTION

The prior art in transporting goods and people have a number of limitations which can be removed by the present invention with the least amount of cost in hardware and energy. By utilising the zero energy travel principle, this invention will allow the transportation of goods with the least amount of energy, depending on the requirement in terms of speed, price of fuel and technology costs.

In order to satisfy the requirement for zero energy travel, two conditions must be met. The first condition is the lowering of losses due to movements; two of the most important are friction and air drag. There are many prior art and technologies that can achieve this in various levels of efficiency. The second condition is that the kinetic energy must be recovered, to be used again when the destination is reached. Also there are many prior art and technologies that can achieve this in various levels of efficiency, but there is no known case of completely combining all of them together to get the total zero energy when travelling.

Electric cars can travel with little friction and can recover kinetic energy but it cannot remove the air drag. The only way to reduce air drag is by removing the air itself. This is only practical in an enclosed space such as tubes or tunnels. The present invention therefor uses tubes that are made of synthetic materials that are preferably non-magnetic such as but not limited to stainless steel, transparent plastics and carbon fibre. Tunnels are holes dug from the earth but may be lined with synthetic materials as before as well but are usually lined with concrete and mortar. The pathway now behaves as a container which may then be made of tubes or tunnels or combinations of said tubes and said tunnels but any opening must be sealed so that outside air cannot leak into tunnel unless required to. In the present invention, the air inside the pathway must be pumped out to reduce its pressure until the desired level of vacuum is achieved.

Inventions exist that allow electric vehicles to travel in vacuum to reduce air drag and even recover energy either magnetically or using gravity, but requires large energy input to maintain the vacuum pump. The present invention modifies the pneumatic tube transport inventions and the vacuum tube transport inventions in order to reduce the cost of providing the vacuum while achieving the zero energy travel principle in a practical manner. The energy used by the pumps may be transferred to the vehicles in the vacuum tubes by using the pneumatic principle. At the same time, the vehicles themselves can behave as vacuum pumps, reducing the requirement for vacuum pumps, while optionally decreasing the time the desired level of vacuum is achieved. The speed of vehicle, comfort of passengers, energy loss and vacuum pumping speed should be optimised to the requirement of the operator of the transportation system. Prior art does not address all these issues together.

The evacuated tube invention does not show where the vacuum pumps are and how the vacuum pumps are to be operated. In the present invention, the pumps are distributed instead of being centrally located. The pumps can be equipped with high pressure release valves. Despite the tube/tunnel being is a state of a low air pressure, when the carriage moves, the carriage will create a high pressure in front of the carriage, which will hinder the movement of the carriages. These high pressure zones operate at a short distance in front of the carriage. Vacuum pumps will operate in front of the carriages when the air pressure is above a specified value, while vacuum pumps/release valves, at the back, should not operate, either automatically by detecting the value of the air pressure, relative to the air pressure in front of the carriage, or by detecting the presence of the carriage, and thus switching off the vacuum pumps and closing all the release valves at the back of the carriages.

The purpose of the vacuum pumps is only to maintain the vacuum inside the tunnel with sufficient safety margin to allow for leaks. It will take a long time and a large number of vacuum pumps to pump all the air out in order to create the desired low pressure values, by using vacuum pumps only. The propulsion system of the vehicles in the tunnels can be utilised to provide additional vacuum pumping power.

That is why a carriage is equipped with a seal that can vary its size and shape. When the carriage stops to pick up passengers, the seal increases in size until preferably all air is completely sealed, while the vacuum pumps in front of the carriage start pumping air out. At the back of the carriage, vacuum pumps stop.

In cases where the carriage seals cannot stop all air, sets of seal doors are installed at the embarkation points of the tubes/tunnels, where the size of the carriage seal will still be maximised to reduce air leakage prior to opening the seal door. A few sets of seal doors may be installed at strategic locations for other purposes such as but not limited to, safety and efficiency. They complement the carriage or vehicle seals to maintain a low air pressure inside the main tunnel, as well as trapping air within the embarkation station, that can be used to propel the vehicles inside the even lower pressure tunnels that have their air being pumped out by vacuum pumps constantly.

Passengers embark on the carriages through doors that are sealed from the tunnel. The tunnels have doors that have flexible airtight rubber hinges all round it so that the seal around the door can be moved to press against the slightly smaller door of the carriage. The seal around the tunnel door is first pressed against the door of the carriage. The tunnel door is then opened, followed by the carriage door. The reverse process is used when closing the doors. This ensures the least air leaking into the tunnel from the outside during embarking and disembarking. Where the tunnels are equipped with these doors, platforms for passengers and for moving goods are provided as well, so these places may be called transit stations.

The slightly lower pressure in front of the carriage assists the carriage in moving but the main propulsion is still provided by various electrical means. It depends on the speed and level of energy economy or comfort required. The requirement is that it should be electrical so that it can reuse the recovered energy from the braking process. Various suspension and propulsion systems may be used. At low speeds, wheels can be used. At medium speeds, magnetic levitations can be used. For maximum speed and comfort, the coil-gun (accelerator) principle may be used.

When the tunnel was first used, it will be filled with air. The vacuum pumps will take a long time to pump air out to the desired pressure. There is no need to wait that long. The carriage itself will act as a vacuum pump. The seal will decrease slightly in size to allow the carriage to move, while large enough to push sufficient air in front of it out through the vacuum pumps situated in front while the speed of vehicle and size of seal adjusted so as not to exceed the vacuum pumping capacity of the pumps in front of the vehicles. When the carriage moves, the vacuum pumps that are left behind will switch off. When the carriage wants to stop at its destination, its kinetic energy is recovered, preferable by using the same propulsion system but operating in the generator mode.

The very first trip may not be efficient or comfortable enough because there is still a lot of air friction and noise. At the return trip in the same tunnel, the pressure has become lower, caused by the pumping action of the carriage as it moves, coupled with the front vacuum pumps. At the start of the reverse trip, the vacuum pumps start operating again while waiting for the carriage to pick up passengers or goods with its seal increased in size to stop the carriage from being sucked, i.e. behaving as an additional brake, as well as maintaining as much as possible, the air that is left behind the seal.

The same process is then repeated for the return trip. It may require a few trips before the operating air pressure is achieved. Once the air pressure is low, maximum speed will increase; noise will be low, thus reducing travel time while increasing comfort levels.

For privately driven electric vehicles, coming from outside the tunnels, a special seal adapter is preferably attached to the front of the vehicle to allow for maximum vacuum pumping action. This seal needs to be transparent or equipped with means to allow the drivers to see in front. This seal also behaves as a protector. Sealable chambers at both ends need to be provided, to allow vehicles to embark and disembark. There will be two door seals per chamber. One door seal is for the inside of the tube/tunnel. The other door seal is for the outside of the tunnel. To embark, the outside air seal need to be opened to allow the vehicles to enter the embarkation chamber. Once the vehicle is inside, the outside door seal need to be closed. Inside the chamber, the vehicle seal need to be attached to the vehicle. There may not be any need for any vacuum pump inside the embarkation chamber. The tube/tunnel door seal is then opened to allow the car to enter the tube/tunnel. The air that has leaking into the chamber will be used to help propel the vehicle inside the low pressure tube which is why vacuum pumps inside the embarkation chamber are not desirable. During the disembarkation on arrival at the disembarkation chamber at the other end, the reverse process is carried out.

The present invention can also be used for vertical motion such as in elevators where the elevators are designed like the carriages. The doors accessing the elevators need to be sealed in the methods shown for the train carriages. Seals need to be attached to the elevators so that they can become a vacuum pump to assist the vacuum pumps at the top and bottom ends of the elevator shafts. For single shaft elevators, the top vacuum pump operates when the elevator goes up, while the bottom vacuum pump stops, and vice versa. For two interconnected shafts, the bottom vacuum pumps will operate when the elevators go down. For the top vacuum pumps, where the shafts are joined together, the vacuum pumps will only operate when both elevators go up. The elevator motor and vacuum pump should be electric so that they can benefit from the kinetic energy recovery system that should store the converted electrical energy into the electrical storage systems.

An alternative way of achieving vacuum is by using inter-connected carriages moving in a loop so that they occupy most of the available space. The vacuum pump does not need to work as hard anymore. The seals around the carriages may not be required. There may not be any need to sequence the switching on and of the vacuum pumps any more. The carriages need not all carry goods or passengers. Some carriages can just be empty or made up of light materials and filled with air. Vertical transportation in a loop for passengers/goods is also possible.

### 4. BRIEF DESCRIPTION OF THE DRAWINGS

The invention is best described by using the following:

FIG. 1 showing the side views of major embodiments,

FIG. 2 showing the side and front views of an embodiment using a car,

FIG. 3 showing the side views of the various phases in using the transportation system using a car,

FIG. 4 showing the side and front views of the process of embarking and disembarking at a transit station and

FIG. 5 showing a series of linked carriages in a loop.

### 5. DETAILED DESCRIPTION OF THE DRAWINGS

The configuration of the present invention will be apparent from the description of embodiments with reference to the accompanying drawings.

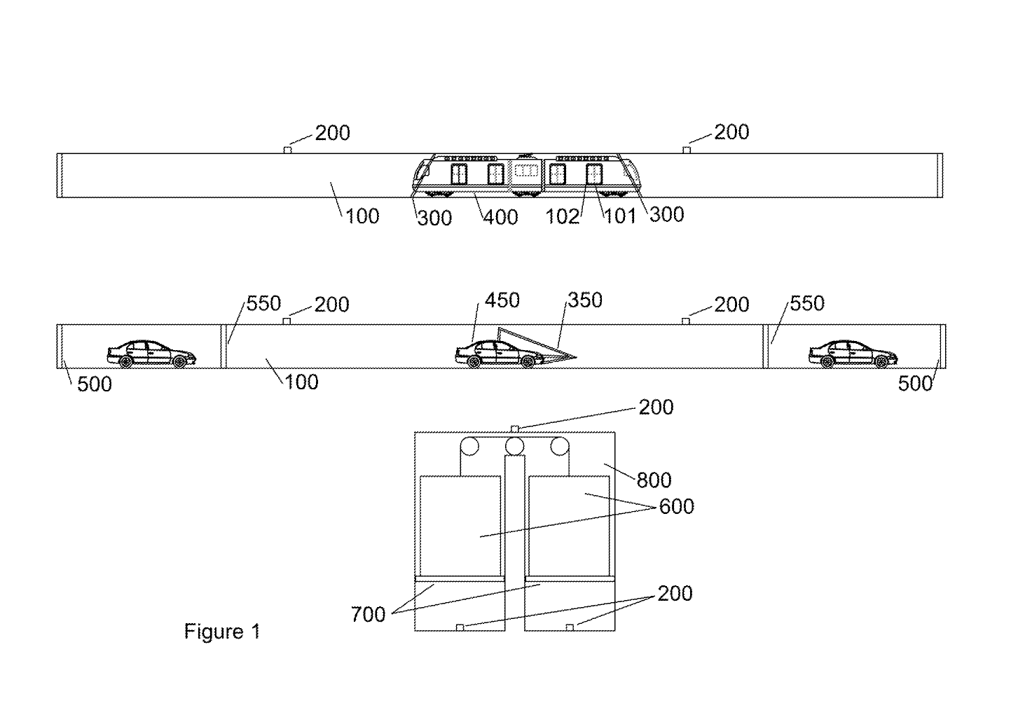

As shown in FIG. 1, the transportation system of the present invention includes a tube/tunnel (100), tunnel door (101), tunnel door seal (102), vacuum pumps (200), a carriage seal (300), a train carriage (400), for a mass transportation system where the carriages remain inside the tube/tunnel. For vehicles coming from outside the tube/tunnel, an attachable car seal (350), a certified vehicle (450), outside air door seal (500), a tunnel door seal (550), using similar tunnel (100) and vacuum pumps (200). For vertical motion, it uses an elevator shaft (800), using the air tight elevators (600) to carry passengers and or cargos, vacuum seals (700) and vacuum pumps (200) strategically located.

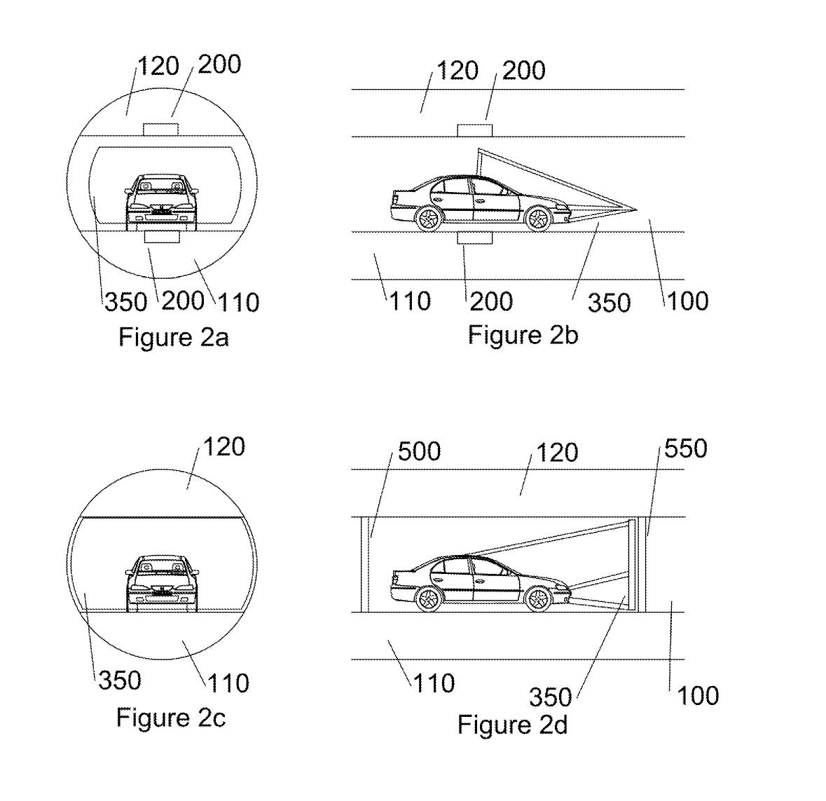

The present invention is able to operate with existing electrical suspension and propulsion systems. The shape of the carriage (400), where goods and/or passengers are to be placed, must be shaped such that it is close to the tube/tunnel (100), while allowing sufficient clearance for turns and undulations. The embodiment therefore has many varieties. The variety depends on the state of the technology and the economical requirements for the day which will be determined by the price of fuel to generate the electricity required to operate the transportation system. The preferred embodiment should be the fastest transport system possible with the lowest air pressure. However, in order to make it possible to understand the concepts behind the present invention, a conventional car, a Honda Accord, suitably prepared for vacuum operation and equipped with electric motor, is used as an example embodiment of the design of the seal with respect to the location of the vacuum pumps, as shown in FIG. 2.

A circular tunnel (100) is divided into an upper access point (110) and a lower access point (120) where vacuum pumps (200) are placed. The car seal (350) is at its smaller size running mode shown in FIG. 2a. Its aerodynamic shape should be such that high pressure zones should be diverted to the upper and lower portions of the tunnel (100). For the sake of simplicity, backup tunnels and other safety features are not shown because someone skilled in the art should be able to design for these other safety features for operations inside tunnels. FIG. 2b is the side view of the running mode of the car running inside an evacuated tube.

FIG. 2c, shows the shape of the seal (350) in the starting position. The seal (350) is at its maximum size so that it can catch the air that will rush into the tunnel when the tunnel door seal is opened. There is no need to install vacuum pumps at this starting position although it may optionally be installed in order to simplify the design of the seals but at the expanse of lower speed of setting up and higher energy loss due to the operation of the vacuum tunnels in the starting position.

FIG. 2d, shows a side view of the starting position of the car in the tunnel. The seal is flat against the door seal but requires a moveable attachment to hold it flat against the door. The control arms can be in the form of hydraulic telescopic tubes. The seals need to be of flexible types such as silicon rubber and coated with Teflon at the edges to reduce friction when it hits against the sides of the wall when the car is moving inside the tunnel. Reinforcement mesh may be needed to maintain its shape when its surface area size is changed, when the air pushes it when it first starts and when it moves at high speed in the lowered air pressure environment.

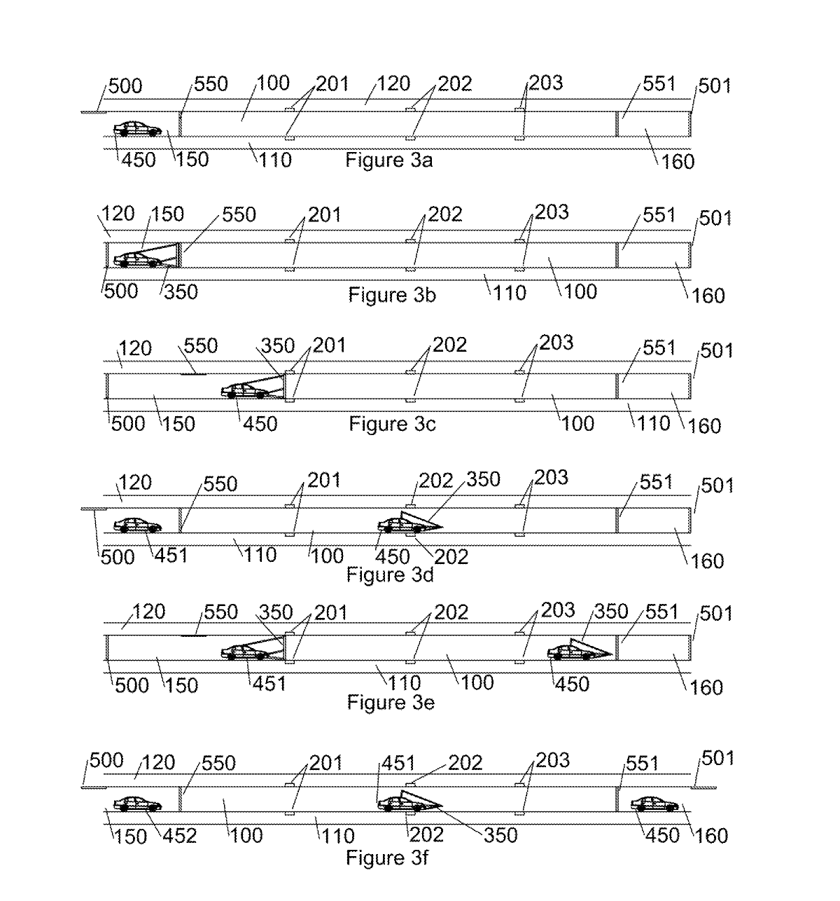

FIG. 3a explains how a car (450) enters the embarkation chamber (150) which is a space enclosed by the outside air door seal (500) and tunnel door seal (550). The outside door seal (500) is opened to allow the car to go inside the embarkation chamber (150). Vacuum pumps (201), (202), (203) are operating. The seal doors (550), (501) and (551) are closed. The disembarkation chamber (160) is enclosed by (501) and (551) seal doors. Inside the tunnel (100), vacuum pumps (201), (202) and (203) pumps air out to the access chambers (110) and (120).

FIG. 3b shows the car seal (350) being attached to the car (450) inside the sealed embarkation chamber (150) with the outside air door seal (500) closed. The car seal (350) is set at its largest size. All vacuum pumps operate.

FIG. 3c shows the car (450) exiting the embarkation chamber (150) and still at a low speed inside the tunnel (100). The tunnel seal door (550) is opened. All vacuum pumps operate.

FIG. 3d shows a second car (451), entering while the earlier car (450) speeds up. Its car seal (350) is now made smaller to be more aerodynamic inside the low air pressure tunnel (100). The vacuum pumps at the rear, (201), are switched off, while vacuum pumps in front (202) and (203) are still on.

FIG. 3e shows a second car (451) still at a low speed helped by vacuum pumps (201) and (202) switching on in front of it. While the first car, (450), having passed vacuum pump (203) by a certain distance, vacuum pump (203) may be switched off. This demonstrates the possibility of complex manipulations on the switching-on of vacuum pumps for multiple cars inside the tunnel. This possibility only occurs when cars are separated from each other at a certain distance. When cars are close together, the distance of which is determined by the pressure level and distance between vacuum pumps, all vacuum pumps may need to be switched on all the time.

FIG. 3f shows the situation when the first car (450) arrives at the disembarkation chamber (160). Outside air door seal (501) is opened, car seal (350) removed.

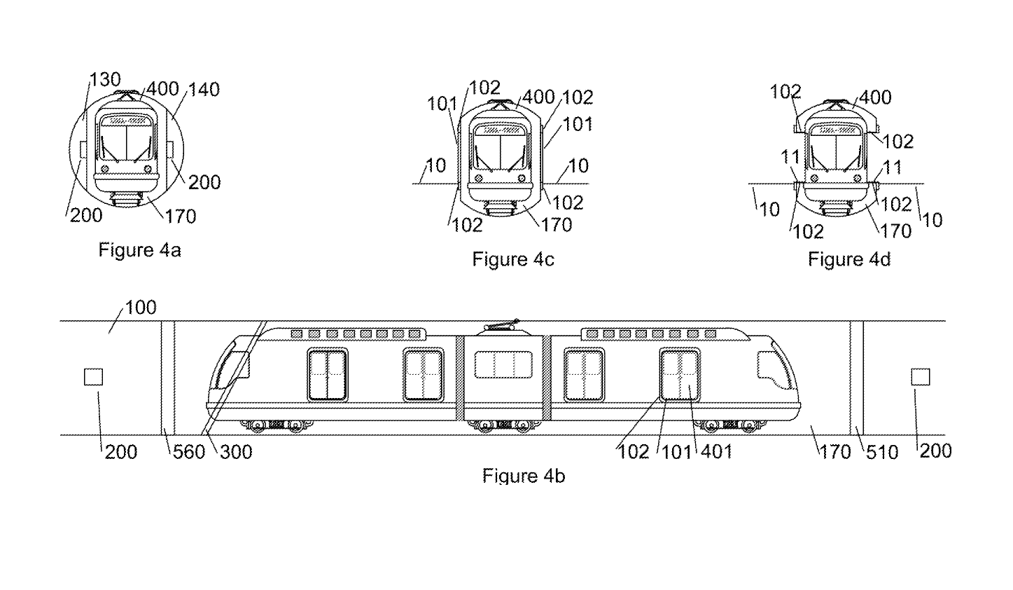

FIG. 4a shows another embodiment using a train carriage (400), inside an evacuated tunnel (100), with side vacuum pumps (200), with left access tunnel (130) and right access tunnel (140). The carriage seal (300), tunnel door (101) and tunnel door seal (102) are shown in FIG. 4b because it is too cluttered to show on the front view of the transportation system in FIG. 4a.

FIG. 4b shows the carriage seal (300), tunnel door seal (101), transit chamber door seal (510) at the entrance, transit chamber door seal (560) at the exit door, when the train carriage (400) stops at a transit station equipped with a transit chamber (170). For a public mass transit system using train carriages, which may be linked together with a number of other train carriages, it is not advisable to have too many chambers because it increases the chance for air leaks into the tunnel (100). What is required is just the tunnel door (101) and tunnel door seal (102) for each door of the carriage at the embarkation places where passengers need to be picked up. However, some chambers need to be installed for maintenance and safety reasons in order to reduce the impact of leaks or other breakdowns, especially for tunnels that are very long.

FIG. 4c shows a front view of a train carriage (400) stopping at an embarkation point for passengers with platform (10). There are tunnel doors (101) and around each tunnel door, the tunnel door seals (102) that are still closed. The tunnel door seals are still folded inside its container. Inside the tunnel (100) the air pressure is reduced, while the platform (10) is at normal atmospheric pressure.

FIG. 4d shows a front view of a train carriage (400) stopping at an embarkation station for passengers using platform (10) when the tunnel door seals (102) are attached to the carriage (400) around the doors of the carriage (401) as in FIG. 4b. At the lower edge of the tunnel door seals (102), platform steps (11) are deployed to reinforce the seals when people walk cross the platform to go inside the carriage through the tunnel door (101) and carriage doors (401), which are opened preferably using the sliding style.

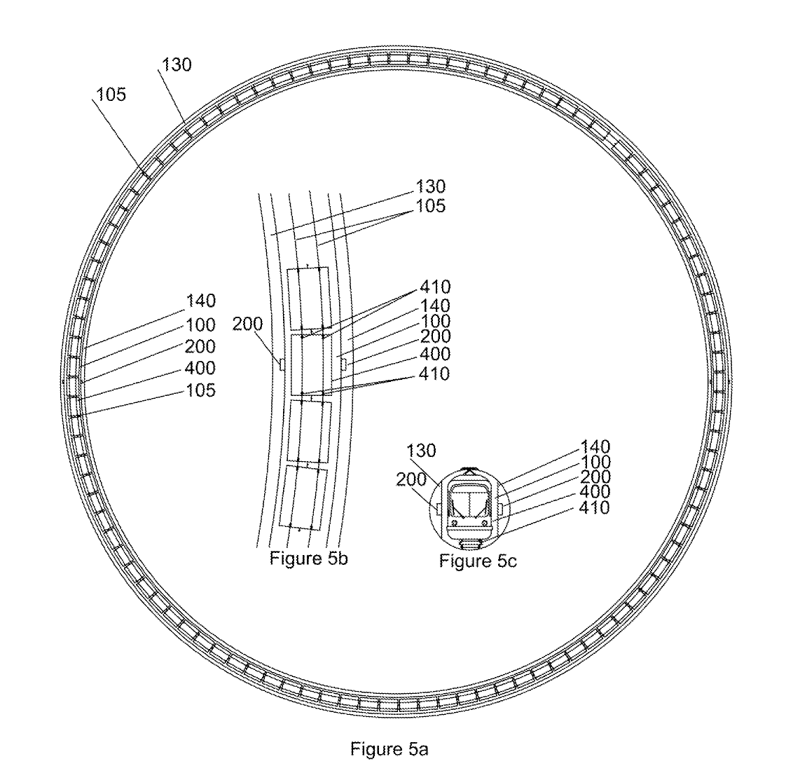

FIG. 5a shows the top view of a series of carriages being linked together into a loop so as to reduce air drag as well as occupy as much air space as possible to reduce the amount of air to be pumped out. The tunnel (100) may optionally be divided into separate partitions for access areas (130) and (140). Vacuum pumps (200) may be placed as before but its number should be less than before because there is less volume of air to pump out. The carriages (400) may run on tracks (105) but may be suspended using magnets instead of wheels and are linked together to form a loop.

FIG. 5b shows a magnified view of a portion of FIG. 5a. Apart from the items shown in FIG. 5a, it now shows the design of the wheels (410). The wheels are designed such that they follow closely the circular tracks.

FIG. 5c shows the front view of the transportation system sliced at a location where the vacuum pumps (200) are placed. It shows the tunnel (100), auxiliary spaces (130) and (140), carriage (400) and wheels (410).

1. A transportation system for passengers and or goods, comprising:
a plurality of interconnected tubes which are man-made materials, and or tunnels which are dug from the earth (100), of cross sections that may be circular or various other suitable shapes, arranged along predetermined routes that may be operated in a plurality of inclinations; and
a plurality of carriages (400) that remain in the said tubes and or said tunnels (100) and or said vehicles (450) that are coming from outside the said tubes or said tunnels (100) and of various shapes and sizes that are pre-certified, for carrying passengers and or goods along the said tubes and or said tunnels (100), along the said predetermined routes, each said carriage (400) and or said vehicle (450) have at least a door (401) for receiving passengers and or cargos, life support system and environmental control system for providing comfort to passengers on board; and
a plurality of transit stations (170) for loading and unloading said carriages (400), wherein each said transit station (170) having means for receiving passengers and or goods through doors (401) at said carriages (400) without allowing air to leak into the said tubes or said tunnels (100); and
a plurality of embarkation (150) and disembarkation (160) chambers for loading and unloading said carriages (400) and or said vehicles (450) as well as attaching vehicle seals (350), wherein each said chamber have at least two sealed doors (500)(501)(550)(551) so that air can leak into the said chambers (150)(160) while not allowing air to leak into the said tubes or said tunnels (100).

2. The transportation system of claim 1, in which said carriages (400) and or said vehicles (450) can be fitted with a plurality of seals (300)(350) where said seals can be adjusted in size and shape to fit the running condition and or shape of said carriages (400) or said vehicles (450), and of such properties that it is slippery and rubbery so that it can also protect the said carriages (400) and or said vehicles (450) without suffering from much energy loss and or damage when the said seals (300)(350) collide with the said tunnel walls or with other said carriages (400) and or said vehicles (450).

3. The transportation system of claim 1, in which said vacuum pumps (200) are fitted to the said tubes and or said tunnels (100) to evacuate air from said tubes and or said tunnels (100), at various strategic places at such said tubes and or said tunnels (100) and in sufficient numbers to provide the vacuum pumping speed desired.

4. The transportation system of claim 1, in which each said vacuum pump (200) is equipped with a remote control system to allow the pumps to be operated remotely and separately, and also said vacuum pumps (200) are equipped with pressure sensors that allow said remote control system to monitor the state of pressure and condition of the said vacuum pump, such that said pressure sensors also allow said vacuum pumps (200) to automatically switch on or off, or remotely controlled by an automatic central monitoring system.

5. The transportation system of claim 1, in which a plurality of transit stations (170) are equipped with a plurality of platforms (10) to allow passengers and or goods to be transported into the said carriages (400) through a plurality of tunnel doors (101) which preferably be slightly larger than each said carriage door (401), and also each said tunnel door (101) being fitted with a moveable air tight tunnel door seal (102) around the said tunnel door (101), in which when the tunnel door (101) is opened, the tunnel door seal (102) will press against the walls around the said doors of the carriages (401) to prevent air from outside to leak into the transit station chamber (170) and at the same time, a platform step (11) is deployed on top of the lower edge of the said tunnel door seal (102) to allow passengers and goods to be transported into the carriages (400).

6. A method of transporting passengers and or cargos comprising steps of:
arranging a plurality of substantially evacuated tubes and or tunnels (100) along predetermined routes; and
providing a plurality of carriages (400) and or attachable seals (300)(350) for various carriages (400) and vehicles (450) for accommodating passengers and or cargos for transporting passengers and or cargos along said predetermined routes, wherein said step of providing, further includes steps of providing seals (300)(350) as in claim 2, providing life supporting equipment and environmental control system on said carriages (400) and or said vehicles (450) for providing comfort to passengers on board; and
arranging a plurality of transit stations (170) at predetermined locations along said routes for loading and unloading of passengers and or cargos, and also providing at said transit stations (170) for said carriages, means to seal air out of the said tubes and or said tunnels (100); and
providing a plurality of embarkation (150) and disembarkation (160) chambers at starting and ending locations for said vehicles (450) or under special circumstances said carriages (400), wherein said step of providing further includes steps of providing air at normal pressure to allow said vehicles (450) to enter or leave and attach or dismantle said vehicle seals (350) to said vehicles (450).

7. The method of claim 6, comprising a further step of providing means to adjust the sizes and shapes of the said seals (300)(350) to suit the speed of the said carriages (400) and said vehicles (450) and the air pressure inside the said tube or tunnels (100), for the purpose of assisting the creation of vacuum and or the movement of the said carriage (450) or said vehicle (450) through pneumatic action and or reduced air drag.

8. The method of claim 6, comprising a further step of providing means to switch on or off individual vacuum pumps (200) in such a way that it assists the movement of the said carriages (400) and said vehicles (450).

9. The method of claim 6, comprising a further step of providing alternative means to reduce the said vacuum pump load and air-drag by joining said carriages (300) together into a continuous loop inside the said tubes and or said tunnels (100).
